(19) United States
(12) Patent Application Publication
(10) Pub. No.: US 2024/0109773 A1
(43) Pub. Date: Apr. 4, 2024

(54) REACTOR FOR CONVERTING DIMETHYL ETHER TO HYDROGEN

(71) Applicant: Oberon Fuels, Inc., San Diego, CA (US)

(72) Inventor: Bipinkumar Patel, Richmond, TX (US)

(21) Appl. No.: 18/063,989

(22) Filed: Dec. 9, 2022

Related U.S. Application Data
(60) Provisional application No. 63/413,136, filed on Oct. 4, 2022.

(51) Int. Cl. C01B 3/32

(52) U.S. Cl. CPC C01B 3/323; C01B 2203/0233; C01B 2203/047; C01B 2203/0475; C01B 2203/1223

(57) ABSTRACT

Methods, devices, and systems are described for a reactor for converting dimethyl ether to hydrogen. The reactor includes an outer tube configured to contain heat. The reactor includes an inner tube nested inside the outer tube, the inner tube configured to conduct the heat contained by the outer tube. The inner tube forms a reaction chamber between the first end and the second end of the plurality of inner tube. The reactor includes a feed line coupled to the end of the plurality of inner tube. The feed line may be configured to pass dimethyl ether and steam to the inner tube. The reactor includes a reactor outlet configured to collect hydrogen from the inner tube and output the hydrogen.

### CROSS-REFERENCE TO APPLICATIONS

This application claims priority to U.S. Provisional Application No. 63/413,136 entitled “REACTOR FOR CONVERTING DIMETHYL ETHER TO HYDROGEN” and filed on Oct. 4, 2022, the disclosure of which is incorporated herein by reference in its entirety.

### TECHNICAL FIELD

The present disclosure relates generally to energy conversion, and more particularly, to a reactor for converting dimethyl ether to hydrogen.

### BACKGROUND

Hydrocarbon fuels are widely used in energy consumption devices and energy production. Many devices and systems utilizing hydrocarbon fuel, such as fuel cells, require fuel to be reformed to produce hydrogen (H 2). For example, fuel cell cars require high-purity hydrogen as fuel for operation. Currently, low-temperature electrolysis and steam methane reforming are used for hydrogen production from water and hydrocarbon fuels respectively. In low-temperature electrolysis, an electrolyzer generates hydrogen from water. This process is highly inefficient due to the high power consumption required by low-temperature electrolysis.

Conventional technologies for the production of hydrogen from natural gas and other fuels also suffer from lower efficiency and excessive carbon dioxide production due to incomplete conversion of methane and carbon monoxide to hydrogen, among other disadvantages. For example, conventional hydrogen production and separation systems, which use a steam methane reformer, suffer from the disadvantages of operating with high temperatures requiring significant amounts of natural gas fuel, and not converting all of the methane to hydrogen. As a result, a substantial amount of feed energy being converted to heat. This generation of heat further results in inefficiencies. Even worse, conventional technologies consumes fossil fuels, require external fuels to facilitate the reaction, and do not use waste heat from other sources to improve efficiency.

These conventional systems also suffer from efficiency losses and cost increases when scaled down from today's typical 500,000 kilograms per day systems. Further, conventional systems typically produce a significant amount of NOx in addition to the high carbon dioxide emissions. This can make obtaining permission to install and operate these conventional systems difficult, particularly in nonindustrial areas. For renewable feeds, such systems operate even less efficiently due to a diluted feed with carbon dioxide and compression requirements for the feed stream. Thus, in order to meet the demand for clean, efficient, sustainable, and mass-produced green/renewable hydrogen, improved technology/processes and reactors for generating hydrogen are needed.

Adapting these current/available processes for onsite production of hydrogen at hydrogen fueling stations or hydrogen fueling transportation hubs is not readily viable. These processes require transportation of hydrogen from production facilities to hydrogen fueling stations, which is very inefficient and costly. The proposed process technologies and the reactor designs described hereafter overcome these hurdles/challenges.

### SUMMARY

The present disclosure relates generally energy conversion, and more particularly, to a reactor for converting dimethyl ether to hydrogen.

In one aspect, disclosed herein are apparatuses for a reactor. The reactor includes an outer tube configured to contain heat, the outer tube having an outer tube diameter. The reactor includes an inner tube nested inside an outer tube, the inner tube configured to conduct the heat contained by the outer tube, the inner tube having an inner tube diameter smaller than the outer tube diameter, the inner tube having a first end and a second end, the inner tube forming a reaction chamber between the first end and the second end of the inner tube. The reactor includes a feed line coupled to the first end of the inner tube, the feed line configured to pass dimethyl ether and steam to the inner tube. The reactor includes a reactor outlet proximate to the second end of the inner tube, the reactor outlet configured to collect hydrogen from the inner tube and output the hydrogen.

In some variations, the reaction chamber is configured to house catalyst, the catalyst being configured to receive the heat contained by the outer tube, and wherein the heat contained by the outer tube has a uniform temperature along an outer tube length. Further, the reaction chamber produces the hydrogen based on a coordinated reaction of the dimethyl ether and steam with the catalyst heated by the heat contained by the outer tube. Additionally, the catalyst includes an acid catalyst and a reforming catalyst. Further, methanol is produced by a hydrolysis of dimethyl ether over the acid catalyst, and wherein a steam reforming of the methanol is produced over the reforming catalyst.

In some variations, the heat contained by the outer tube is steam heat and the inner tube is configured to conduct heat contained in the outer tube. Further, the outer tube and the inner tube are oriented in a vertical direction. Additionally, the outer tube further comprises a steam inlet for the outer tube and a steam condensate outlet for the outer tube. Further, a spacing between the outer tube and the inner tube allows the steam to circulate and condense inside the outer tube

In another aspect, disclosed herein are apparatuses for another reactor. The reactor includes a casing configured to contain heat. The reactor includes a plurality of tubes nested inside the casing, the plurality of tubes configured to conduct the heat contained by the casing, the plurality of tubes each having a first end and a second end, the plurality of tubes each forming a reaction chamber between the first end and the second end of each of the plurality of tubes. The reactor includes a feed line coupled to each of the first end of the plurality of tubes, the feed line configured to pass dimethyl ether and steam to the plurality of tubes. The reactor includes a reactor outlet proximate to each of the second end of the plurality of tubes, the reactor outlet configured to collect hydrogen from the plurality of tubes and output the hydrogen.

In some variations, the heat is generated by a plurality of electric heating elements inside the casing and outside the plurality of tubes and wherein the plurality of tubes is configured to conduct the heat contained by the casing. Additionally, the casing further comprises a refractory surface along an inside portion of the casing and wherein the casing further comprises a layer of insulation between the refractory surface and an outside portion of each of the plurality of tubes.

In yet another variation, disclosed herein are apparatuses for another reactor. The reactor includes a shell configured to contain heat. The reactor includes a plurality of tubes nested inside the shell, the plurality of tubes configured to conduct heat from the heat contained inside the shell, the plurality of tubes each having a first end and a second end, and the plurality of tubes each forming a reaction chamber between the first end and the second end. The reactor includes a feed line coupled to each of the first end of the plurality of tubes, the feed line configured to receive dimethyl ether and steam. The reactor includes a reactor outlet proximate to each of the second end of the plurality of tubes, the reactor outlet configured to output hydrogen.

In some variations, the reactor further includes a plurality of burners inside the shell, the burners configured to generate the heat contained inside the shell and the reactor further includes a shell outlet configured to output flue gas. Further, the plurality of burners are configured to turn on simultaneously maintaining uniform temperature and wherein the shell is a fire box.

In yet another variation, disclosed herein are apparatuses for another reactor. The reactor includes a shell configured to contain heat. The reactor includes a top tube plate coupled to a top portion of the shell, the top tube plate including a plurality of top tube plate apertures. The reactor includes a bottom tube plate coupled to a bottom portion of the shell, the bottom tube plate including a plurality of bottom tube plate apertures. The reactor includes a plurality of tubes configured to extend between the top tube plate and the bottom tube plate, each of the plurality of tubes configured to be inserted inside a top tube plate aperture of the plurality of top tube plate apertures and a bottom tube plate aperture of the plurality of bottom tube plate apertures; the plurality of tubes configured to conduct heat from the heat contained inside the shell, the plurality of tubes each forming a reaction chamber between the top tube plate and the bottom tube plate. The reactor includes a feed line proximate to the top portion of the shell, the feed line being configured to pass dimethyl ether and steam to the plurality of tubes. The reactor includes a reactor outlet proximate to the bottom portion of the shell, the reactor outlet configured to collect hydrogen from the plurality of tubes and output the hydrogen.

In some variations, the reaction chamber is configured to house a catalyst, the catalyst being configured to receive the heat contained by the plurality of tubes, and wherein the heat contained by the shell has a uniform temperature between the top tube plate and the bottom tube plate. Further, the shell and the plurality of tubes are oriented in a vertical direction. Additionally, the shell further comprises an inlet for heating the plurality of tubes with at least one of steam or heating oil, and wherein the shell further comprises an outlet for outputting condensate from inside the shell. Further, a spacing between the shell and the plurality of tubes allows at least one of steam or heating oil to circulate inside the plurality of tubes.

In yet another variation, disclosed herein are apparatuses for another reactor. The reactor includes a shell including a reaction chamber, the reaction chamber configured to contain a fluidized catalyst reaction bed. The reactor includes a heat source configured to extend from a top portion of the reaction chamber to a bottom portion of the reaction chamber, the heat source configured to heat the fluidized catalyst reaction bed. The reactor includes a feed line proximate to the bottom portion of the reaction chamber, the feed line including a plurality of feed line apertures, each feed line aperture of the plurality of feed line apertures is configured to pass dimethyl ether and steam to the reaction chamber. The reactor includes a reactor outlet proximate to the top portion of the shell, the reactor outlet configured to collect hydrogen from the reaction chamber and output the hydrogen.

In some variations, the shell is oriented in a vertical direction and wherein the fluidized catalyst reaction bed is configured to circulate inside the reaction chamber. Further, the heat source winds in alternating directions through the reaction chamber, where the heat source is at least one of an electric coil or a tube containing steam, and where the fluidized catalyst reaction bed is configured to conduct the heat from at least one of the electric coil or tube containing steam. Additionally, the reaction chamber produces the hydrogen based on a coordinated reaction of the dimethyl ether and steam with the fluidized catalyst reaction bed heated by the heat source. Further, the shell further may include a dimethyl ether and steam outlet coupled to the feed line, the dimethyl ether and steam and steam outlet configured to output excess dimethyl ether and steam and steam from the reaction chamber to the feed line for recycling the excess dimethyl ether and steam.

In yet another variation, disclosed herein are systems for measuring reactions. The reaction-measuring system also includes a feed line valve configured to control dimethyl ether and steam flowing into an inner tube, the inner tube being nested inside an outer tube, the inner tube configured to conduct heat contained by the outer tube, the inner tube having an inner tube diameter smaller than an outer tube diameter, the inner tube each forming a reaction chamber. The system also includes a heat sensor configured to determine a temperature of the heat contained by the outer tube. The system also includes a controller communicatively coupled to the feed line valve and the heat sensor, the controller configured to. The system also includes determine the temperature of the heat contained by the outer tube based on the heat sensor. The system also includes adjust, in response to the temperature of the heat satisfying a temperature threshold, a feed flow rate with the feed line valve.

In some variations, the reaction-measuring system includes a steam-to-dimethyl ether ratio sensor configured to output a steam-to-dimethyl ether ratio reading representative of a steam-to-dimethyl ether ratio in the reaction chamber, where the controller is communicatively coupled to the steam-to-dimethyl ether ratio sensor and is further configured to: determine the steam-to-dimethyl ether ratio reading based on the steam-to-carbon ratio sensor; compare the steam-to-dimethyl ether ratio reading to a steam-to-a-carbon ratio; and adjust, in response to the comparing, the feed flow rate with the feed line valve.

In some variations, the system further includes a pressure sensor configured to output a pressure reading representative of the outlet pressure in the outlet line and a back pressure valve in the outlet line configured to control the outlet pressure at the outlet line. The controller is communicatively coupled to the pressure sensor and the back pressure valve, and where the controller is further configured to: determine the pressure reading inside the outlet line based on the pressure sensor; and adjust, in response to the pressure reading satisfying an outlet pressure threshold, the outlet pressure with the back pressure valve in the outlet line.

In some variations, the system includes at least one of a carbon monoxide sensor or a carbon dioxide sensor configured to output at least one of a carbon monoxide reading or a carbon dioxide reading representative of at least one of carbon monoxide or carbon dioxide inside of the reaction chamber. The controller is communicatively coupled to the at least one of the carbon monoxide sensor or the carbon dioxide sensor and the controller is further configured to: determine the at least one of a carbon monoxide or a carbon dioxide inside of the reaction chamber based on at least one of the carbon monoxide sensor or the carbon dioxide sensor; and adjust, in response to the at least one of a carbon monoxide reading or a carbon dioxide reading satisfying at least one of a carbon monoxide threshold or a carbon dioxide threshold, the feed flow rate with the feed line valve.

In some variations, the system includes a hydrogen sensor configured to output a hydrogen reading representative of the hydrogen at a reactor outlet proximate to an end of the inner tube, the hydrogen sensor reading indicative of a coordinated reaction of the dimethyl ether and the steam with a catalyst in the reaction chamber. The controller is communicatively coupled to the hydrogen sensor and is further configured to determine the hydrogen reading at the reactor outlet proximate to the end of the inner tube based on the hydrogen sensor; and adjust, in response to the hydrogen reading satisfying a hydrogen threshold, the feed flow rate with the feed line valve.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 depicts an example of a steam-heated reactor contained within an inner tube nested in an outer tube configured to contain steam;

FIG. 2A depicts an example of an electrically heated reactor within a tube nested in a casing configured to contain heat generated from a heating element;

FIG. 2B depicts an example of a cross-section of an electrically heated reactor within a tube nested in a casing configured to contain heat generated from a heating element;

FIG. 3 depicts an example of a burner-heated reactor including a plurality of tubes nested in a shell configured to contain heat generated by fuel fired burners;

FIG. 4 depicts an example of a dual-plate reactor including a plurality of tubes extending between a top tube plate and a bottom tube plate;

FIG. 5 depicts a fluidized catalyst reactor including a fluidized catalyst reaction bed nested inside of a reaction chamber configured to contain a heat source extending from a bottom portion of the reaction chamber to the top portion of the heat chamber;

FIG. 6A depicts a table showing exemplary specifications for the dimethyl ether being fed into a feed line to the reactor for converting dimethyl ether to hydrogen;

FIG. 6B depicts a table showing exemplary specifications for the steam being fed into a feed line to the reactor for converting dimethyl ether to hydrogen;

FIG. 6C depicts an example of a table showing an exemplary expected product composition from the reactor;

FIG. 6D depicts an example of a table showing exemplary specifications for the purified hydrogen leaving the pressure swing adsorption system after the reactor converts the dimethyl ether to hydrogen;

FIG. 7 depicts an example of a block diagram showing the overall process flow for converting dimethyl ether and steam into hydrogen;

FIG. 8 depicts an example of a block diagram showing the DME and Steam feed process flow for converting dimethyl ether to hydrogen;

FIG. 9 depicts an example of a block diagram showing the purification process for hydrogen;

FIG. 10 depicts an example of a block diagram including a controller configured to send an instruction to reactor hardware based on a reactor sensor; and

FIG. 11 depicts a block diagram illustrating a computing system consistent with implementations of the current subject matter.

### DETAILED DESCRIPTION

The methods, systems, and apparatuses described herein are for a reactor for converting dimethyl ether to hydrogen. In the following detailed description, reference is made to the accompanying drawings, which form a part hereof. In the drawings, similar symbols generally identify similar components, unless context dictates otherwise. The illustrative alternatives described in the detailed description, drawings, and claims are not meant to be limiting. Other alternatives may be used and other changes may be made without departing from the spirit or scope of the subject matter presented here. It will be readily understood that the aspects, as generally described herein, and illustrated in the Figures, can be arranged, substituted, combined, and designed in a wide variety of different configurations, all of which are explicitly contemplated and make part of this application.

The reactors described herein are configured to convert dimethyl ether to hydrogen. Unlike conventional systems, the reactors described herein are clean, efficient, and well-suited for mass-producing hydrogen by using renewable dimethyl ether (DME) as feedstock to produce renewable hydrogen. The reactors receive mixed steam and dimethyl ether in a feed line. The feed line passes the mixed steam and dimethyl ether into the reaction chamber. The reaction chamber houses a catalyst configured to receive heat to convert the steam and dimethyl ether into hydrogen. The reaction chamber produces the hydrogen based on a coordinated reaction between the dimethyl ether and steam mixture and the catalyst in response to the catalyst and the reactants being heated.

The reactors described herein may be of an isothermal design. The isothermal design may enable a thermodynamic process in which the temperature of the reactor system remains fairly constant. The transfer of heat into the system occurs at a rate that the thermal equilibrium is maintained. Unlike conventional systems, saturated steam at a specified pressure may be used to allow the reaction to take place at a constant temperature. In some embodiments, the reactor design may be a multi-tube reactor where each tube is filled with catalysts. Each tube may be supplied with steam to maintain a constant reaction temperature within the inner tube. The latent heat from steam condensation may provide the required heat for the reaction and maintain the constant temperature.

The isothermal design and heat sources of the reactors are a significant improvement over conventional systems that require extremely high temperatures to operate. In contrast to operating temperatures of upwards of 1000° C. in conventional systems, the isothermal design of the reactors described herein may have an operating temperature between 225 and 300° C. Additionally, the operating pressure of the reactors described herein may be between 8 to 17 bars, the molar ratio of steam to dimethyl ether may be between 2 to 4.

Unlike conventional systems for creating hydrogen, a catalyst may be heated to induce the reaction from dimethyl ether to hydrogen. Dimethyl ether can be reacted (or reformed) using water in the form of steam to produce hydrogen using a catalyst based on the Gibbs free energy and the theoretical thermodynamic reaction equations. The understanding of the Gibbs free energy requires the use of particular catalysts to allow the necessary reactions to occur and which ones to suppress. An acid catalyst and a copper-zinc catalyst (reforming catalyst) may be used to convert the dimethyl ether to hydrogen.

The catalyst requires heat to produce the hydrogen. The conversion reactions for dimethyl ether to hydrogen are endothermic and require heat supply for the reaction. More specifically, the catalyst and the reactants require heat to have a coordinated reaction between the dimethyl ether and the steam mixture to produce hydrogen. The heat may pass into the reaction chamber. The heat passed into the reaction chamber may be contained by an inner tube, a shell, a casing, an outer tube, and/or the like. The heat may be generated by steam, an electrically powered heating element, a fuel firing, a heated oil, and/or the like. In one example, the heat may be contained by an outer tube with a nested inner tube. The inner tube may be configured to conduct heat contained in the outer tube. Spacing between the outer tube and the inner tube may allow the heat (e.g., steam) to circulate and condense inside the outer tube. One feature of the reactor may be the ability to coordinate the heat demand to produce the reaction and the ability to supply the heat required from the heating medium.

In some embodiments, a tube may be configured to produce 50 kg of hydrogen a day or more. The outer dimensions of the tube may control the dimensions of the reaction chamber. The dimensions of the reaction chamber may be selected based on the reactivity of the components and the heat transfer to the catalyst in the reaction chamber and the required gas hourly space velocity. That is, a balanced reactivity of the components being converted to hydrogen must be coordinated with the heat transfer between the catalyst to the dimethyl ether and steam mixture. The reaction and the action of the timing must be coordinated and balanced. If the reaction and the heat transfer are not in sync, then inefficient hydrogen conversion may result in the non-reaction of excessive components. That is, an improper temperature may result in an unbalanced heat transfer and incomplete reactions. Incomplete reactions lead to waste or excessive emissions and energy inefficiency.

To increase the likelihood that the reaction and the heat transfer are coordinated inside the reactor, a two-step process for producing hydrogen from dimethyl ether via steam reforming may be based on the reaction kinetics and Gibbs free energy principles. First, methanol may be produced by the hydrolysis of dimethyl ether over an acid catalyst, followed by steam reforming of methanol over a copper-zinc catalyst. The dimethyl ether steam reforming reaction may be endothermic. In the process of producing hydrogen, the hydrolysis reaction of dimethyl ether to methanol may be the limiting reaction. A catalyst may enhance the reaction to produce hydrogen. Methanol may be an intermediate product in the process of dimethyl ether steam reforming. Catalysts containing copper and zinc oxide may promote both the production of hydrogen and methanol.

Carbon dioxide and carbon monoxide may be byproducts of the two-step process. But the carbon dioxide and carbon monoxide byproducts may be minimized by appropriate process operating conditions and, if required, by a water gas shift reaction. The carbon monoxide mole fraction may increase with increasing temperature for a given steam-to-dimethyl ether ratio and decrease with an increasing steam-to-dimethyl ether ratio at a given temperature. To minimize carbon monoxide and optimize hydrogen production, a relatively lower temperature range and a relatively higher steam-to-dimethyl ether ratio may be applied in the reaction chamber. Additionally, decreasing the operating pressure may increase hydrogen production efficiency based on the Le Chatelier's principles.

Based on the above thermodynamics, an ideal catalyst may be the bi-functional catalyst. The bi-functional catalyst may be a physical mixture of acid catalyst for DME hydrolysis, and copper-zinc catalyst for methanol steam reforming.

The catalyst may include an acid catalyst and a reforming catalyst. Methanol may be produced by hydrolysis of dimethyl ether over the acid catalyst, and a steam reforming of the methanol may produce hydrogen over the reforming catalyst. In some embodiments, one-third of the catalyst may be the acid catalyst, and two-thirds of the catalyst may be the reforming catalyst (copper-zinc) mixture. The acid catalyst may be a hydrolysis catalyst. The acid catalyst may convert or hydrolyze a sufficient amount of dimethyl ether to methanol.

Reaction thermodynamics suggests that dimethyl ether to hydrogen conversion reaction may take based on a reaction temperature, reaction pressure, catalyst properties, and steam-to-dimethyl ether ratios. In some embodiments, the reactor operating temperature may be between 225 and 300° C., the reactor operating pressure may be between 8-17 bars, the molar ratio of steam to dimethyl ether may be between 2 to 4, and the saturated high-pressure steam (used as a heating medium) may be between 4.0 and 10 MPa (580-1450 PSIG). The gas hourly space velocity for designing the reactor may depend primarily on catalyst physical, chemical properties, and on various operating conditions (e.g., temperature, pressure, steam-to-dimethyl ether ratio).

The maximum hydrogen conversion efficiency of approximately 97% may occur at a steam-to-dimethyl ether ratio of 2, a temperature of 200° C., and an absolute pressure of 1 atm based on thermodynamic simulations.

The dimethyl ether and steam may be converted to hydrogen using one of five different reactors. One type of reactor may include an inner tube nested inside an outer tube with steam circulating between the inner tube and the outer tube to induce a heat-based reaction inside the inner tube. A multiple of these reactors may be combined depending on the hydrogen production capacity. Another type of reactor may include a tube nested inside a casing having electric heating elements to heat the tube to induce a heat-based reaction inside the tube. A multiple of these reactors may be combined depending on the hydrogen production capacity. Yet another type of reactor may include tubes nested inside of a shell (furnace) where heat from burners circulates inside the shell to induce a heat-based reaction inside the tubes. Yet another type of reactor may include tubes extending between tube plates inside of a shell where heat circulates inside the shell to induce a heat-based reaction inside the tubes. Yet another type of reactor may include a fluidized catalyst reaction bed nested inside of a reaction chamber with a heat source extending from a bottom portion of the reaction chamber to the top portion of the heat chamber to induce a heat-based reaction at the fluidized catalyst reaction bed. In some embodiments, features from one type of reactor may be combined with another type of reactor.

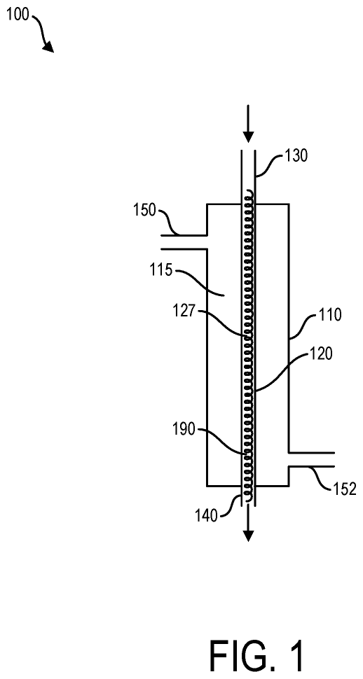

FIG. 1 depicts an example of a steam-heated reactor 100 contained within an inner tube 120 nested in an outer tube 110 configured to contain steam. The steam-heated reactor 100 may include an outer tube 110, an inner tube 120 nested inside the outer tube 110, a feed line 130 coupled to the inner tube 120 at one end, and a reactor outlet 140 coupled to the inner tube 120 at the other end. The hydrogen production capacity of a plurality of steam-heated reactors 100 may be 1,000 kg/day or more. The steam-heated reactor 100 may use the reaction of dimethyl ether with water vapor (steam) to produce hydrogen. This reaction may also be defined as the reforming of dimethyl ether to hydrogen.

The reactor may include an outer tube 110. The outer tube 110 may be configured to contain heat. The outer tube 110 may have an outer tube 110 diameter. In some embodiments, the outer tube 110 diameter is three inches to four inches. The outer tube 110 may be configured to contain steam or a heating oil. The heat contained by the outer tube 110 may have a uniform temperature along the outer tube length. In some embodiments, the outer tube 110 may extend from 10 feet to 25 feet long.

The steam-heated reactor 100 may include an inner tube 120 nested inside the outer tube 110. The inner tube 120 may be configured to conduct the heat contained by the outer tube 110. The inner tube 120 may have an inner tube 120 diameter smaller than the outer tube 110 diameter. The inner tube 120 may have a first end and a second end. Between each of the ends, the inner tube 120 may have a reaction chamber 190. The inner tube 120 may house the reaction chamber 190. In some embodiments, the diameter of the inner tube 120 may be between 1¼ inches to 2 inches. The inner tube 120 may include a catalyst 127 in the reaction chamber 190 for the reaction of the dimethyl ether to hydrogen. In some embodiments, a combination of steam-heated reactors 100 with inner tubes nested in outer tubes may extend 10 to 25 feet long for producing 1000 kg/day or more of hydrogen.

The outer tube 110 and inner tube 120 may have the same length. In some embodiments, the length of the outer tube 110 may be the same length as the inner tube 120. The outer tube 110 and the inner tube 120 may form the steam-heated reactor 100 for converting dimethyl ether and steam to hydrogen. The inner tube 120 may be filled with a catalyst 127. A spacing 115 between the outer tube 110 and the inner tube 120 may enable steam to circulate and condense inside the outer tube 110. In some embodiments, the steam circulating inside the spacing 115 between the outer tube 110 and the inner tube 120 may be 245 to 310 degrees Celsius. The inner tube 120 may conduct heat for heating the catalyst 127 and the reactants. The steam may condense, and the conducted heat by the inner tube 120 may pass to the catalyst 127 and the reactants. The number and length of outer tubes having inners tubes with reaction chambers may vary to meet the demands of capacity and engineering.

In some embodiments, the outer tube 110 and the inner tube 120 may be oriented in a vertical direction with the first end proximate to the upper portion of the outer tube 110 and the second end proximate to the bottom portion of the outer tube 110. The outer tube 110 may include a steam inlet 150 and a steam condensate outlet 152. The steam inlet 150 may receive the steam and the steam condensate outlet 152 may release condensate. The temperature inside of the outer tube 110 may be uniform across the length of the inner tube 120. In some embodiments, the uniform temperature contained in the outer tube 110 may be the condensation temperature of the steam. In some embodiments, the steam may condense at only one temperature to increase the likelihood of the steam temperature being uniform throughout the outer tube 110. Steam can be an advantageous source of heat as the rate of condensation may be indicative of the rate at which the inner tube 120 absorbs the heat and the rate of reactions.

The outer tube 110 with the inner tube 120 having the catalyst 127 may be arranged with a plurality of steam-heated reactors having outer tubes with inner tubes in a ring format or a box format. In some embodiments, the outer tubes of the plurality of steam-heated reactors may be arranged inside of cylindrical, square, or rectangular box. The cylindrical, square, or rectangular box may include steam inlets and steam outlets for receiving heating steam and releasing steam condensate. The cylindrical, square, or rectangular box may also be a casing, a shell, a housing, and/or the like.

The steam-heated reactor 100 may include a feed line 130 for feeding dimethyl ether and steam into the reaction chambers inside the inner tube 120. The feed line 130 may be coupled to the first end of the inner tube 120. A single feed line 130 may be connected to each of the first ends of the inner tube 120 where there are a plurality of steam-heated reactors. The first end of the inner tube 120 may be the top end of the inner tube 120. The feed line 130 may be configured to pass dimethyl ether and steam to the inner tube 120.

The steam-heated reactor 100 may include a reactor outlet 140 proximate to the second end of the inner tube 120. The reactor outlet 140 may collect hydrogen from the inner tube 120 and output the hydrogen. The second end of the inner tube 120 may be the bottom end of the inner tube 120.

The reaction chamber inside the inner tube 120 may be configured to house a catalyst 127. The catalyst 127 may be configured to receive the heat contained by the outer tube 110. The reaction chamber 190 may produce hydrogen based on a coordinated reaction of the dimethyl ether and steam with the catalyst 127 heated by the heat contained by the outer tube 110.

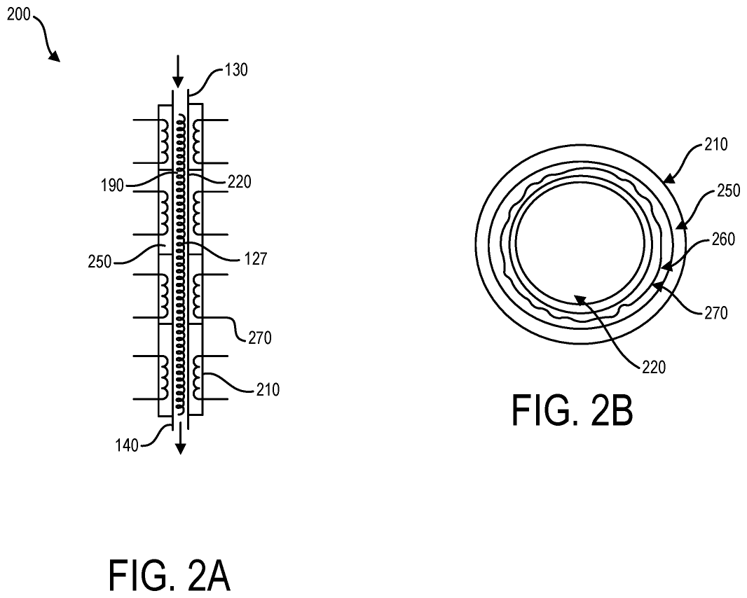

FIG. 2A depicts an example of an electrically heated reactor 200 within a tube 220 nested in an outer casing 210 configured to contain heat generated from an electrically powered heating element 270. The electrically heated reactor 200 may include an outer casing 210, a tube 220 nested inside the casing, a feed line 130 coupled to the tube 220 at one end, and a reactor outlet 140 coupled to the other end of the tube 220. The hydrogen production capacity of a plurality of electrically heated reactors may be 1,000 kg/day or more. The electrically heated reactor 200 may use the reaction of dimethyl ether with water vapor to produce hydrogen. This reaction may also be defined as the reforming of dimethyl ether to hydrogen.

The electrically heated reactor 200 may include an outer casing 210. The outer casing 210 may be configured to contain an insulation layer 250 and an inner refractory layer 260. The inner refractory layer 260 may be configured to contain the a tube and the electrically powered heating element 270. The heat in the inner refractory layer 260 may be generated by the electrically powered heating element 270. The electrically powered heating element 270 may be embedded inside the inner refractory layer 260 in the spacing 115 between the tube 220 and outer wall of the inner refractory layer 260. The electrically powered heating element 270 may be electric coils. The heat contained by the casing may have a uniform temperature along the length of the casing. In some embodiments, the outer casing 210 may include a refractory surface along an inside portion of the outer casing 210. The outer casing 210 may include the insulation layer 250 between the inner refractory layer 260 and the inside portion of the outer casing 210. The insulation layer 250 may prevent heat leaking to the outside of the casing. In some embodiments, the outer casing 210 with the nested tube 220 may extend from 10 feet to 40 feet long.

The electrically heated reactor 200 may include the tube 220 nested inside the outer casing 210. The tubes may be configured to conduct the heat contained by the outer casing 210. The tube 220 may have an tube diameter smaller than the outer casing 210. The tube may be configured to conduct the heat contained by the outer casing 210. The tubes may have a first end and a second end. Between each of the ends, the tube 220 may have a reaction chamber 190. The tube 220 may house the reaction chamber 190. In some embodiments, the diameter of the tube may be between 1½ inches to four inches. The tube may include a catalyst 127 in the reaction chamber 190 for the reaction of the dimethyl ether to hydrogen. In some embodiments, a combination of electrically heated reactors with inner tubes nested in outer casings may extend 10 to 25 feet long for producing 1000 kg/day or more of hydrogen.

With a plurality of electrically heated reactors, each of the tubes may have the same length. In some embodiments, the length of the outer casings may be the same length as the tubes. The outer casing 210 and the tube 220 may form the reaction chamber 190 for converting dimethyl ether and steam to hydrogen. The tube 220 may be filled with a catalyst 127. In some embodiments, the electrically powered heating element 270 may heat the tubes to be between 245 to 310 degrees Celsius. The tube 220 may conduct heat for heating the catalyst 127 and the reactants. The number and length of outer casings having inners tubes with reaction chambers may vary to meet the demands of capacity and engineering.

In some embodiments, the tube 220 may be oriented in a vertical direction, with the first tube end proximate to a top portion of the outer casing 210 and the second tube end proximate to a bottom portion of the outer casing 210. The temperature inside of the casing may be uniform across the length of the tube. The uniform temperature contained in the casing may be controlled by the electrically powered heating element 270. The electrically powered heating element 270 may be one or more electric coils.

A plurality of outer casings with a plurality of tubes having the catalyst 127 may be arranged in a ring format or a box format. In some embodiments, the outer casings may be arranged inside of a cylindrical, square, or rectangular box. The cylindrical, square, or rectangular box may house power cables with switches for electrical coils. The cylindrical, square, or rectangular box may also be a casing, a shell, a housing, and/or the like.

The electrically heated reactor 200 may include a feed line 130 for feeding dimethyl ether and steam into the reaction chambers inside the tubes. The feed line 130 may be coupled to the first end of the tubes. Additionally, and/or alternatively, a single feed line 130 may be connected to each of the first ends of the inner tubes where there are a plurality of electrically heated reactor. The first end of the tube may be a top end of the tube 220. The feed line 130 may be configured to pass dimethyl ether and steam to the tube 220.

The electrically heated reactor 200 may include a reactor outlet 140 proximate to the second end of the tube 220. The reactor outlet 140 may collect hydrogen from the tube 220 and output the hydrogen. The second end of the tube 220 may be the bottom end of the tube 220.

FIG. 2B depicts an example of a cross-section of an electrically heated reactor 200 within a tube 220 nested in an outer casing 210 configured to contain heat generated from a heating element 270. The electrically heated reactor 200 may include an outer casing 210 and a tube 220 nested inside the outer casing 210. An insulation layer 250 may be situated between the inside of the outer casing 210 and the tube 220 nested inside the outer casing 210. An inner refractory layer 260 may include the electrically powered heating element 270 and be situated between the insulation layer 250 and tube 220. The tube 220 may include a catalyst 127.

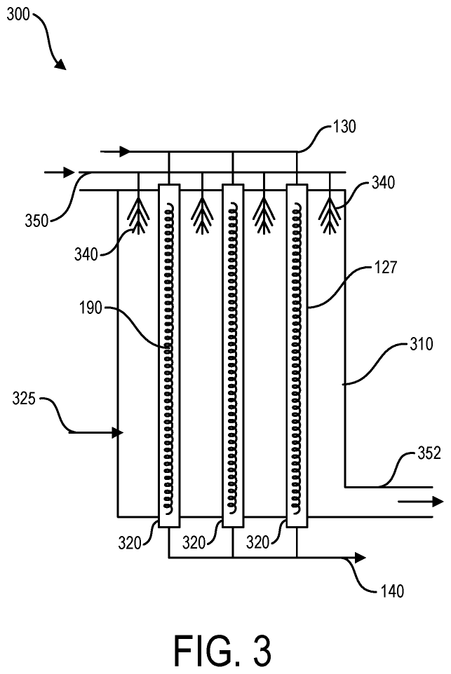

FIG. 3 depicts an example of a burner-heated reactor 300 including a plurality of nested tubes 320 nested in a shell 310 configured to contain heat generated by burning fuel. The burner-heated reactor 300 may include the shell 310, the plurality of nested tubes 320 inside the shell 310, fuel burners 340, a feed line 130 coupled to each of the tubes at one end, and a reactor outlet 140 coupled to the other end of the tubes. The shell 310 may be a fire box or a cylindrical shell. The hydrogen production capacity of the burner-heated reactor 300 may be 1,000 kg/day or more. The burner-heated reactor 300 may use the reaction of dimethyl ether with water vapor (steam) to produce hydrogen. This reaction may also be defined as the reforming of dimethyl ether to hydrogen.

The burner-heated reactor 300 may include the shell 310. The shell 310 may be configured to contain heat. The plurality of nested tubes 320 with catalyst 127 may be inside the shell 310. The shell 310 may contain a hot flue gas heating media from the fuel burners 340. The shell 310 may be a fire box, a cylindrical shell, a square box, or a rectangular box including hot flue gases from the combustion of fuel. The shell 310 may include a fuel gas inlet 350 and a flue gas outlet 352 for receiving fuel and air for the fuel burners and for the outlet of flue gases, respectively. The box or cylinder may also be a casing, a shell, a housing, and/or the like. The shell 310 may be configured to contain heat generated by burning fuel.

The inside of the shell 310 may include a refractory surface 325. The shell 310 may be composed of refractory to retain heat at elevated temperatures. The fuel burners 340 may be configured to generate the heat contained inside the shell 310. The fuel burners 340 may be situated at the top of the shell 310 and oriented downward for vertical firing. Additionally, and/or alternatively, In some embodiments, the fuel burners 340 may also be placed on the vertical walls of the shell 310 for horizontal firing. A fuel burner may be controlled independently from other fuel burners. In some embodiments, the fuel burners 340 may be configured to turn on simultaneously to maintain a uniform temperature inside the shell 310. The heat is produced by burning of fuel with atmospheric air in the fuel burners 340 and heat radiation from the refractory surface 325. The fuel gas and atmospheric air may enter the fuel burners 340 through the fuel gas inlet 350. The hot flue gas produced by burning of the fuel may exit the shell 310 through a flue gas outlet 360. The hot flue gas may circulate in a spacing 115 between the tubes inside the shell 310 and the inner walls inside the shell 310. The radiant heat contained by the refractory surface 325 of the shell 310 and the heat contained in the hot flue gas may maintain a uniform temperature along the length of the plurality of nested tubes 320. In some embodiments, The shell 310 may include a layer of insulation on the outside portion of the shell 310. The layer of insulation may prevent heat leaking to the outside of the shell 310. In some embodiments, the shell 310 may extend 10 feet to 40 feet high in a vertical direction to house the plurality of nested tubes 320.

The burner-heated reactor 300 may include the plurality of nested tubes 320 inside the shell 310. The plurality of nested tubes 320 may be configured to conduct the heat contained by the shell 310. The plurality of nested tubes 320 may have a first end and a second end. Between each of the ends, the plurality of nested tubes 320 may house a reaction chamber 190. In some embodiments, the diameter of the plurality of nested tubes 320 may be between 1½ inches to four inches. The plurality of nested tubes 320 may include a catalyst 127 in the reaction chamber 190 for the reaction of the dimethyl ether to hydrogen. The plurality of nested tubes 320 may extend 10 to 40 feet long for producing 1000 kg/day or more of hydrogen.

The plurality of nested tubes 320 may have the same length. In some embodiments, the length of the shell 310 may be the same length as the plurality of nested tubes 320. The shell 310 and the plurality of nested tubes 320 may form the reaction chambers for converting dimethyl ether and steam to hydrogen. The plurality of nested tubes 320 may be filled with a catalyst 127. Spacing 115 between the shell 310 and the plurality of nested tubes 320 may enable heat from hot flue gases and the radiation heat from the refractory surface 325 to heat the plurality of nested tubes 320, the catalyst 127, and reactants. The flue gas may exit the shell 310 via the flue gas outlet 352. In some embodiments, the heat circulating inside the spacing 115 between the shell 310 and the plurality of nested tubes 320 may be higher than 300 degrees Celsius. The plurality of nested tubes 320 may conduct heat for heating the catalyst 127 and the reactants. In some embodiments, the fuel burners 340 may be arranged close to the refractory surface 325 of the shell 310. The number and length of the plurality of nested tubes 320 with reaction chambers may vary to meet the demands of capacity and engineering.

In some embodiments, the plurality of nested tubes 320 may be oriented in a vertical direction, with the first tube ends proximate to the top portion of the shell 310 and the second tube ends proximate to the bottom portion of the shell 310. The temperature inside of the shell 310 may be uniform across the length of the plurality of nested tubes 320. In some embodiments, the uniform temperature contained in the shell 310 may be the hot flue gases and radiation heat from the refractory surface 325.

The burner-heated reactor 300 may include a set of feed lines for feeding dimethyl ether and steam into the reaction chambers inside the tubes. The plurality of nested tubes 320 may be coupled to the first end of the plurality of nested tubes 320. Additionally, and/or alternatively, a single feed line 130 may be connected to each of the first ends of the plurality of nested tubes 320. The first ends of the plurality of nested tubes 320 may be the top end of the plurality of nested tubes 320. The feed lines may be configured to pass dimethyl ether and steam to the plurality of nested tubes 320.

The burner-heated reactor 300 may include a reactor outlet 140 proximate to the second end of the plurality of nested tubes 320. The reactor outlet 140 may collect hydrogen from the plurality of nested tubes 320 and output the hydrogen. The second ends of the plurality of nested tubes 320 may be the bottom ends of the plurality of nested tubes 320.

The reaction chamber 190 inside the plurality of nested tubes 320 may be configured to house a catalyst 127. The catalyst 127 may be configured to receive the heat contained by the shell 310. The reaction chamber may produce hydrogen based on a coordinated reaction of the dimethyl ether and steam with the catalyst 127 heated by the heat contained by the shell 310.

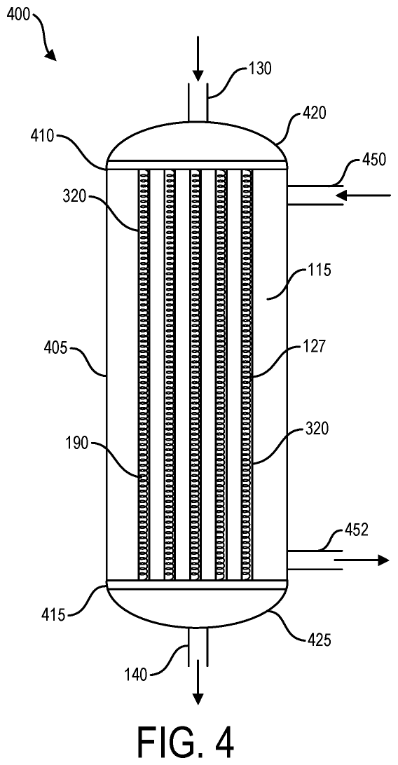

FIG. 4 depicts an example of a dual-plate reactor 400 including a plurality of tubes extending between a top tube plate 410 and a bottom tube plate 415. The dual-plate reactor 400 may include a cylindrical shell 405, a top tube plate 410, a bottom tube plate 415, a top dish end 420, a bottom dish end 425, a plurality of nested tubes 320 extending between the top tube plate 410 and the bottom tube plate 415, a feed line 130 proximate to the top dish end 420 of the cylindrical shell 405, and a reactor outlet 140 proximate to the bottom dish end 425 of the cylindrical shell 405. The hydrogen production capacity of the dual-plate reactor 400 may be 1,000 kg/day or more. The dual-plate reactor 400 may use the reaction of dimethyl ether with water vapor to produce hydrogen. This reaction may also be defined as the reforming of dimethyl ether to hydrogen. The dual-plate reactor 400 including the plurality of nested tubes 320 extending between the top tube plate 410 and the bottom tube plate 415 may have a horizontal configuration or a vertical configuration.

The dual-plate reactor 400 may include a cylindrical shell 405. The cylindrical shell 405 may include a plurality of tubes with catalyst 127. The cylindrical shell 405 may contain common heating media such as steam or hot oil surrounding the tubes. In some embodiments, dual-plate reactor 400 may not include individual heating steam jacket or hot oil jackets. The cylindrical shell 405 may include a first inlet 450 and a first outlet 452 for receiving steam or hot oil and for outlet of condensate or hot oil respectively. The cylindrical shell 405 may include the feed line 130 and the reactor outlet 140 for feeding dimethyl-ether mixture and hydrogen product outlet. The cylindrical shell 405 may also be a casing, a shell, a housing, and/or the like. The cylindrical shell 405 may be configured to contain heat.

The cylindrical shell 405 may be configured to contain a top tube plate 410 coupled to the top dish end 420 of the cylindrical shell 405 and configured to contain a bottom tube plate 415 coupled to the bottom dish end 425 of the cylindrical shell 405. The top tube plate 410 may include apertures in the top tube plate 410. The bottom tube plate 415 may include apertures in the bottom tube plate 415. The cylindrical shell 405 may be configured to contain steam or a heating oil. The heat may circulate in a spacing 115 between the tubes inside the cylindrical shell 405 and the inner walls inside the cylindrical shell 405. The heat contained by the cylindrical shell 405 may have a uniform temperature along the length of the cylindrical shell 405. In some embodiments, the cylindrical shell 405 may extend from 10 feet to 25 feet long.

The dual-plate reactor 400 may include the plurality of nested tubes 320 inside the cylindrical shell 405. The plurality of nested tubes 320 may be configured to conduct the heat contained by the cylindrical shell 405. The plurality of nested tubes 320 may have a first end and a second end. The plurality of nested tubes 320 at the first end may be configured to be inserted into the apertures at the top tube plate 410. The plurality of nested tubes 320 at the second end may be configured to be inserted into the apertures in the bottom tube plate 415. Between each of the ends, the plurality of nested tubes 320 may have a reaction chamber 190. The tube may house the reaction chamber 190. In some embodiments, the diameter of the tube may be between 1¼ inches to two inches. The plurality of nested tubes 320 may include a catalyst 127 in the reaction chamber 190 for the reaction of the dimethyl ether to hydrogen. The plurality of nested tubes 320 may extend 10 to 25 feet long for producing 1000 kg/day or more of hydrogen.

The plurality of nested tubes 320 may have the same length. In some embodiments, the length of the cylindrical shell 405 may be the same length as the plurality of nested tubes 320. The cylindrical shell 405 and the plurality of nested tubes 320 may form the dual-plate reactor 400 for converting dimethyl ether and steam to hydrogen. The plurality of nested tubes 320 may be filled with a catalyst 127. Spacing 115 between the cylindrical shell 405 and the plurality of nested tubes 320 may enable steam to circulate and condense inside the cylindrical shell 405. In some embodiments, the heat circulating inside the spacing 115 between the cylindrical shell 405 and the tubes may be 245 to 310 degrees Celsius. The plurality of nested tubes 320 may conduct heat for heating the catalyst 127. The steam may condense, and the conducted heat by the tube may pass to the catalyst 127 and reactants. The number and the length of the plurality of nested tubes 320 may vary to meet the demands of capacity and engineering.

In some embodiments, the plurality of nested tubes 320 may be oriented in a vertical direction, with the first tube ends proximate to the top portion of the cylindrical shell 405 and the second tube ends proximate to the bottom portion of the cylindrical shell 405. The temperature inside of the cylindrical shell 405 may be uniform across the length of the tube with circulating heating oil or steam. In some embodiments, the uniform temperature contained in the cylindrical shell 405 may be the condensation temperature of the steam. In some embodiments, the steam may condense at only one temperature to increase the likelihood of the steam temperature being uniform throughout the cylindrical shell 405. Steam can be an advantageous source of heat as the rate of condensation may be indicative of the rate at which the tube absorbs the heat.

The dual-plate reactor 400 may include a feed line 130 for feeding dimethyl ether and steam into the top dish end 420 of the cylindrical shell 405 for distribution to the reaction chambers inside the plurality of nested tubes 320. The feed line 130 may be coupled to the top dish end 420 of the cylindrical shell 405. The first ends of the plurality of nested tubes 320 may be the top end of the plurality of nested tubes 320. The feed line 130 may be configured to pass dimethyl ether and steam to the plurality of nested tubes 320.

The dual-plate reactor 400 may include a reactor outlet 140 proximate to the second end of the plurality of nested tubes 320. The reactor outlet 140 may collect hydrogen from the plurality of nested tubes 320 and output the hydrogen.

The reaction chamber 190 inside the plurality of nested tubes 320 may be configured to house a catalyst 127. The catalyst 127 may be configured to receive the heat contained by the cylindrical shell 405. The reaction chamber 190 may produce hydrogen based on a coordinated reaction of the dimethyl ether and steam with the catalyst 127 heated by the heat contained by the cylindrical shell 405.

In some embodiments, the dual-plate reactor 400 may be oriented in a horizontal direction where the top dish end 420 and the bottom dish end 425 correspond to a left and right dish ends, a top tube plate 410 corresponds to a left tube plate, a bottom tube plate 415 corresponds to a right tube plate, the plurality of nested tubes 320 extend between the left tube plate and the right tube plate, the feed line 130 may be proximate to the left dish portion of the cylindrical shell 405, and the reactor outlet 140 may be proximate to the right dish portion of the cylindrical shell 405.

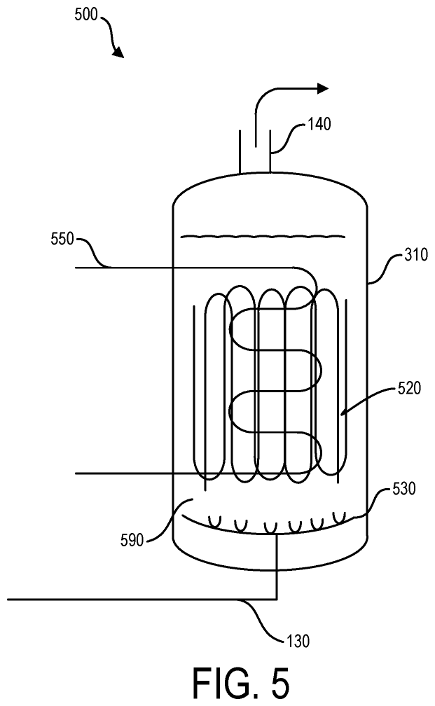

FIG. 5 depicts a fluidized catalyst reactor 500 including a fluidized catalyst reaction bed 520 nested inside of a heat chamber 590 configured to contain a heat source 550 extending from a bottom portion of the heat chamber 590 to the top portion of the heat chamber 590. The fluidized catalyst reactor 500 may include a shell 310, a heat source inside the shell 310, a feed line 130 proximate to the bottom portion of the shell 310, and a reactor outlet 140 proximate to the top portion of the shell 310. The hydrogen production capacity of the fluidized catalyst reactor 500 may be 1,000 kg/day or more. The fluidized catalyst reactor 500 may use the reaction of dimethyl ether with water vapor to produce hydrogen. This reaction may also be defined as the reforming of dimethyl ether to hydrogen.

The fluidized catalyst reactor 500 may include a shell 310. The shell 310 may be configured to contain heat. The shell 310 may be configured to include the heat chamber 590. The heat chamber 590 may be configured to contain a fluidized catalyst reaction bed 520. The fluidized catalyst reaction bed 520 may extend from the top portion of the shell 310 to the bottom portion of the shell 310. The fluidized catalyst reaction bed 520 may extend from one lateral side of the shell 310 to the opposite lateral side of the shell 310. The fluidized catalyst reaction bed 520 may be configured to receive the heat contained by the shell 310. The reaction chamber may produce hydrogen based on a coordinated reaction of the dimethyl ether and steam with the fluidized catalyst 127 bed heated by the heat contained by the shell 310. The fluidized catalyst 127 bed may include a fluidized acid catalyst and a fluidized reforming catalyst. Methanol may be produced by hydrolysis of dimethyl ether over the fluidized acid catalyst, and a steam reforming of the methanol may be produced over the fluidized reforming catalyst. In some embodiments, one-third of the fluidized catalyst may be the fluidized acid catalyst, and two-thirds of the fluidized catalyst may be the fluidized reforming catalyst (copper-zinc) mixture. The fluidized acid catalyst may be a hydrolysis catalyst. The fluidized acid catalyst may convert a sufficient amount of dimethyl ether to methanol. The fluidized hydrolysis catalyst may hydrolyze dimethyl ether to methanol.

The fluidized catalyst reactor 500 may include a heat source 550 that extends from the top portion of the heat chamber 590 to the bottom portion of the heat chamber 590. The heat source 550 may be heating coils configured to heat the fluidized catalyst reaction bed 520. The heat source 550 may be steam or heating oil inside of a tube or coil. Additionally, and/or alternatively, the heat source 550 may be a heating element configured to be electrically powered to generate heat. The heat source 550 may extend from the top portion of the heat chamber 590 to the bottom portion of the heat chamber 590 by alternating in opposite directions vertically or horizontally in a zig-zag or a coil pattern. In some embodiments, the heat source 550 may extend across the shell 310 in a first horizontal direction until reaching the first side of the shell 310, extend in a perpendicular direction, and then extend across the shell 310 in a second horizontal direction opposite the first horizontal direction until reaching a second side of the shell 310. In some embodiments, the power source may extend across the shell 310 in a first vertical direction until reaching a top or bottom portion of the shell 310, extend in a perpendicular direction, and then extend across the shell 310 in a second vertical direction opposite the first vertical direction until reaching the opposite end of the shell 310. The heat contained by the heat chamber 590 and the fluidized catalyst reaction bed 520 in the shell 310 may have a uniform temperature throughout the fluidized catalyst reaction bed 520. In some embodiments, the shell 310 may extend from 10 feet to 25 feet long.

The fluidized catalyst reactor 500 may include the fluidized catalyst reaction bed 520 nested inside the shell 310. The fluidized catalyst reaction bed 520 may be configured to conduct the heat contained by the heat source 550. The fluidized catalyst reaction bed 520 is the reaction chamber for the reaction of the dimethyl ether to hydrogen.

The shell 310, the heat source 550, and the fluidized catalyst reaction bed 520 may form the fluidized catalyst reactor 500 for converting dimethyl ether and steam to hydrogen. Spacing 115 between the heating coils/tubes of the heat source 550 and the fluidized catalyst reaction bed 520 may enable heat to circulate and condense the shell 310. In some embodiments, the heat source 550 may be 245-310 degrees Celsius. Heat from the tubes/coils of the heat source 550 may be conducted to the fluidized catalyst 127 and the reactants. The temperature inside of the shell 310 and the fluidized catalyst reaction bed 520 may be uniform.

The fluidized catalyst reactor 500 may include a feed line 130 for feeding dimethyl ether and steam into the heat chamber 590. The feed line 130 may be proximate to the bottom portion of the shell 310. The feed line 130 may be configured to pass dimethyl ether and steam to the shell 310. The feed line 130 may include a diffuser 530 with a series of openings configured to evenly disperse the dimethyl ether and steam into the heat chamber 590.

The fluidized catalyst reactor 500 may include a reactor outlet 140 proximate to the top portion of the shell 310. The reactor outlet 140 may collect hydrogen from the reaction chamber and output the hydrogen. In some embodiments, a filter may be placed between the reaction chamber and the reactor outlet 140.

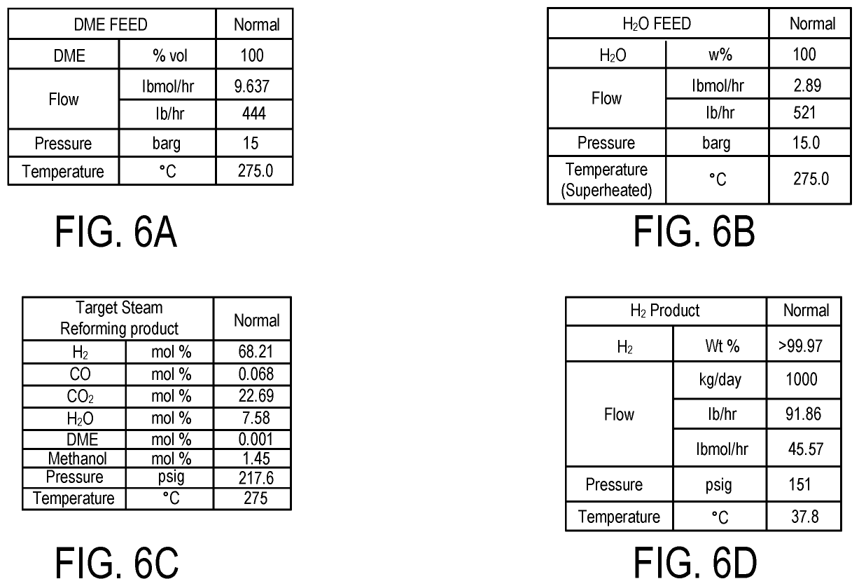

Referring to FIG. 6A, illustrated is a table showing exemplary specifications for the dimethyl ether being fed into a feed line to the reactor for converting dimethyl ether to hydrogen.

Referring to FIG. 6B, illustrated is a table showing exemplary specifications for the steam being fed into a feed line to the reactor for converting dimethyl ether to hydrogen.

Referring to FIG. 6C, illustrated is an example of a table showing an exemplary expected product composition from the reactor.

Referring to FIG. 6D, illustrated is an example of a table showing exemplary specifications for the purified hydrogen leaving the pressure swing adsorption system after the reactor converts the dimethyl ether to hydrogen.

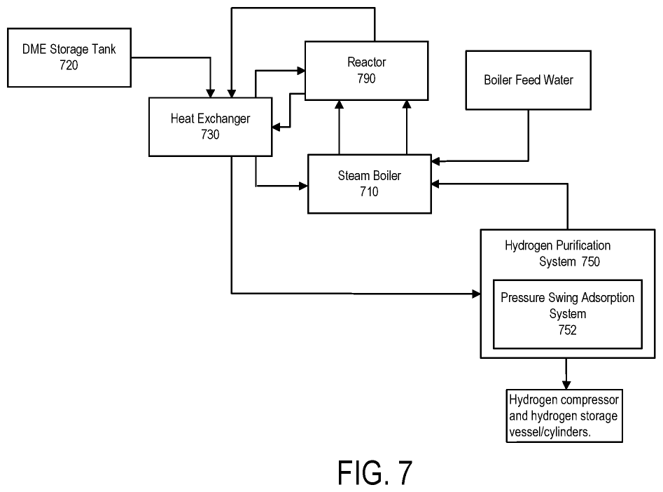

Referring to FIG. 7, illustrated is an example of a block diagram showing the process flow for converting dimethyl ether and steam into hydrogen. The process may include receiving the dimethyl ether from a storage tank 720, increasing the temperature of the dimethyl ether using a heat exchanger 730, mixing steam from a steam boiler 710 with the dimethyl ether, and inputting the heated dimethyl ether and steam mixture into the reactor 790. In addition to being mixed with the dimethyl ether, the steam from the steam boiler 710 may be input into the reactor 790 for heating the catalyst 127. The hydrogen generated by the reactor 790 may pass through the heat exchanger 730 to cool the hydrogen and simultaneously heat the incoming dimethyl ether before passing through to a hydrogen Purification system 750 that includes a pressure swing adsorption system 752. The hydrogen purification system 750 may also include a cooling system for the reactor product, a water wash column, and a carbon dioxide removal system.

The dimethyl ether may be delivered to the site and stored in a storage tank 720, such as a pressurized vessel. The dimethyl ether may be pumped from the storage tank 720 to be heated by heat exchangers. The heat exchangers may be configured to perform a heat exchange process to heat the dimethyl ether using heat from recycled steam. In some embodiments, the dimethyl ether may be heated using the recovered heat from the reactor 790.

The steam for heating the reactor 790 may be generated by a high-pressure boiler 710. In some embodiments, the high-pressure boiler 710 may be fueled by tail gas of the pressure swing adsorption system 752 and supplemented by dimethyl ether from the storage tank 720 for boiling the water into steam. The tail gas fueling the high-pressure boiler 710 may be from the tail gas drum. For example, the tail gas used to fuel the high-pressure boiler 710 may be unconverted reactants and carbon monoxide produced by the reactor 790 and then subsequently separated by a pressure swing adsorption system 752 from the high-pressure hydrogen product. In some embodiments, the tail gas from the pressure swing adsorption system 752 may contain some unrecovered hydrogen and may be supplemented by a small amount of dimethyl ether to be used as fuel for the high-pressure boiler 710. The tail gas may also be a purge gas of the pressure swing adsorption system 752.

The steam from the high-pressure boiler 710 may be mixed in with the dimethyl ether to produce the steam and dimethyl ether mixture. The steam and dimethyl ether mixture may be further heated by a heat exchanger 730 to reach a reaction temperature threshold for the reactor 790. The reaction temperature threshold may correspond to the required temperature for the combination of dimethyl ether and steam to react with the catalyst 127 inside the reactor 790. The mixed dimethyl ether and steam may enter into the reactor 790 at the top portion of the reactor 790. Additionally, the steam from the boiler 710 may be split to supply the heat for the reactor 790 and to supply the steam for being mixed with the dimethyl ether to be input into the reactor 790. For example, the steam from the boiler 710 may be configured to heat the outer tubes or shell of the reactor 790. The steam from the boiler 710 may satisfy the reaction temperature threshold for inducing the reaction between the catalyst 127 in the reaction chamber and the steam and dimethyl ether mixture. In some embodiments, the reaction of dimethyl ether, steam, and the catalyst 127 inside the reactor 790 may be performed at a reaction temperature satisfying a reaction temperature threshold and a reaction pressure satisfying a reaction pressure threshold. The steam from the high-pressure boiler 710 may be regulated to for flow, pressure, and temperature to satisfy reaction requirement and to balance the temperature of the steam and to regulate the formation of condensation at the reactor 790.

In some embodiments, the reactor product may pass through a hydrogen purification system 750. The hydrogen purification system 750 may include cooling the reactor product in a water-cooled exchanger. The hydrogen purification system 750 may include removing condensed water and methanol from the cooled reactor product using a hot condensate drum. The removed condensate (water and methanol) may be pumped out by the condensate pump to be sent to the reactor 790 through a condensate vaporizer. The unconverted methanol may then be recycled to the inlet of the reactor 790 for further conversion. Once most of the water and methanol is removed by the hot condensate drum, the hydrogen-rich gas may flow to the water wash column and to the carbon dioxide removal process before advancing to the pressure swing adsorption system 752 for hydrogen purification.

The pressure swing adsorption system 752 may include a plurality of pressure adsorption vessels, a product filter, and automated switching valves managed by a cycle controller. The pressure swing adsorption system 752 may be configured to remove impurities from the reactor product (e.g., unpurified hydrogen 905). The impurities may include carbon monoxide, carbon dioxide, steam condensate, and minor quantities of unconverted methanol and dimethyl ether. The purified hydrogen from the pressure swing adsorption system 752 may be further compressed and stored inside a compressed hydrogen storage tank or hydrogen cylinders. The purified hydrogen product from the pressure swing adsorption system 752 may be further compressed by the product hydrogen compressor. Compressed hydrogen may be stored or shipped for consumption. The tail gas (including impurities in the raw reactor product) from the pressure swing adsorption system 752 may be sent to a tail gas drum, and then sent to the boiler 710 to be used as fuel gas. In some embodiments, demineralized water and the steam condensate may be sent to the deaerator to remove oxygen. An oxygen scavenger and pH adjustment chemical may be added to the treated water. The treated water may be pumped out by a boiler feed water pump and sent to the boiler 710. The boiler 710 may include the boiler feed water pump.

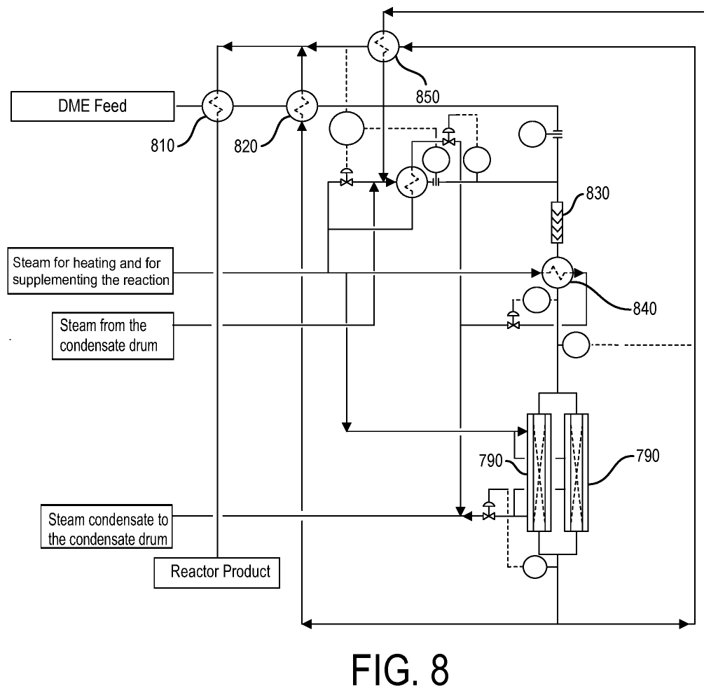

Referring to FIG. 8, illustrated is an example of a block diagram showing the process flow for converting dimethyl ether to hydrogen. The process may include receiving the dimethyl, increasing the temperature of the dimethyl ether using a heat exchanger, mixing steam from a steam boiler 710 with the dimethyl ether, and inputting the heated dimethyl ether and steam mixture into the reactor 790.

Dimethyl ether may enter into a first heat exchanger 810 to vaporize the dimethyl ether. The first heat exchanger 810 may be configured to heat and vaporize the dimethyl ether using steam condensate from the reactor 790. In some embodiments, the dimethyl ether entering the first heat exchanger 810 may be heated by the reactor product output from the reactor 790.

At a second heat exchanger 820, the dimethyl ether may be further heated to satisfy a temperature threshold associated with a temperature requirement for mixing the dimethyl ether with steam. Once the dimethyl ether satisfies the threshold temperature associated with a temperature requirement for mixing the dimethyl ether with steam, the dimethyl ether may enter into a mixer 830. The mixer 830 may be configured to mix dimethyl ether with steam. The steam entering the mixer 830 may be received from a steam boiler 710. Following the mixture process of dimethyl ether with steam, the mixed dimethyl ether and steam may enter into a third heat exchanger 840.

At the third exchanger, the dimethyl ether may be further heated to satisfy a reaction temperature threshold. The reaction temperature threshold may correspond to the required temperature for the combination of dimethyl ether and steam to react with the catalyst 127 inside the reaction chamber. In some embodiments, the third heat exchanger 840 may be heated by steam coming directly from the boiler 710. The temperature of the steam from the boiler 710 may satisfy the reaction temperature threshold for bringing the combination of dimethyl ether and steam to the reaction temperature threshold. Once the dimethyl ether and steam mixture satisfies the reaction temperature threshold, the dimethyl ether and steam may enter into the reactor 790.

The steam used to heat the reactor 790 at a uniform temperature may form steam condensate. The condensate may be flashed in a high pressure condensate drum to produce a lower pressure steam that is fed to the reactor along with the dimethyl ether. Additional steam may be required to meet the steam-to-dimethyl ether ratio for the reactor feed can be supplemented by steam from the boiler 710. The reactor product from reactor 790 may be used to heat the condensed liquid from the hot condensate drum in a fourth heat exchanger 860, the first heat exchanger 810, and the second heat exchanger 820. The first heat exchanger 810, the second heat exchanger 820, and the third heat exchanger 850 may be heated using steam condensate from the reactor system. The steam may have been previously used to heat the reaction chamber and may condense.

The steam from the boiler 710 may be used to heat the reaction chamber for producing hydrogen. More specifically, the steam from the boiler 710 may be used to induce the reaction between the catalyst 127 in the reaction chamber and the dimethyl ether and steam combination to produce hydrogen. The condensation from heating the reaction chamber may leave the reaction chamber to enter into the high-pressure condensate drum. The steam condensate from high-pressure condensate drum may be configured to enter into a deaerator. In some embodiments, the condensate in the deaerator may be configured to enter back into the boiler 710.

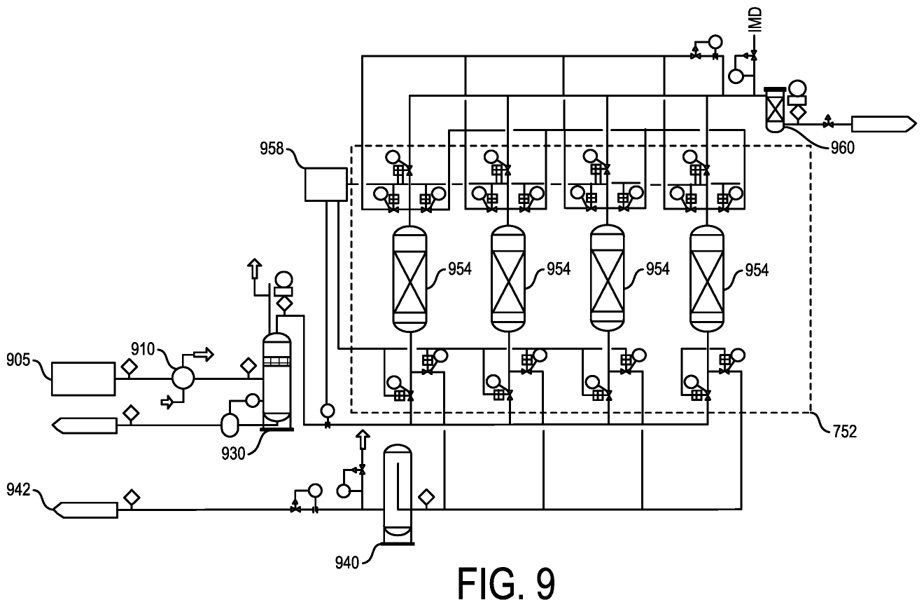

Referring to FIG. 9, illustrated is an example of a block diagram showing the purification process for hydrogen. The purification process may include cooling the reactor product (e.g., unpurified hydrogen 905), removing the water from the hydrogen, washing the reactor product with a cold water wash, removing the carbon dioxide from the reactor 790, and purifying the hydrogen with a pressure swing adsorption system 752.

The unpurified hydrogen 905 from the reactor 790 may enter into a cooler 910. The cooler 910 may be configured to help transform the steam in the unpurified hydrogen 905 to water. The unpurified hydrogen 905 may enter into a condensate drum 930 with the water being condensed out of the unpurified hydrogen 905. The gas output of the condensate drum 930 may enter into the water wash column and then the carbon dioxide removal system before advancing to the pressure swing adsorption system 752.

The pressure swing adsorption system 752 may be configured to remove the carbon dioxide and carbon monoxide from the unpurified hydrogen 905. The pressure swing adsorption system 752 may include a bed of adsorbents 954 for collecting and removing the methane, carbon dioxide, and carbon monoxide and minor amounts of unconverted methanol and dimethyl ether. The pressure swing adsorption system 752 may be configured to receive the unpurified hydrogen 905 to remove the condensate, carbon monoxide, methane, and carbon dioxide from the unpurified hydrogen 905 with the bed of adsorbents 954 through a pressurization and depressurization process. The pressurization and the depressurization process may be controlled by the cycle controller 958 communicatively coupled to each of the pressure swing adsorbers in the pressure swing adsorption system 752. The pressure swing adsorption system 752 may output purified hydrogen. In some embodiments, the adsorbents may be selected per the type of impurities present in the feed stream. For example, silica gel or alumina may be added for water removal, activated carbon may be added for carbon dioxide removal, and zeolite may be added for methane removal, carbon monoxide removal, and nitrogen removal. Adsorption of the impurities may occur at a relatively high pressure (typically 20-50 bars). Adsorption of the impurities may occur at a relatively high temperature, such as about 50-60° C. (120-140° F.). The operating pressure may be 200 PSIG, and targeted PSA hydrogen recovery may be 80-85%. The tail gas (including impurities in the reactor product) from the pressure swing adsorption system 752 may be sent to a tail gas drum 940, and then sent to the boiler 710 to be used as fuel gas. The purified hydrogen may pass through a final filter 960 before being further compressed stored or shipped for consumption.

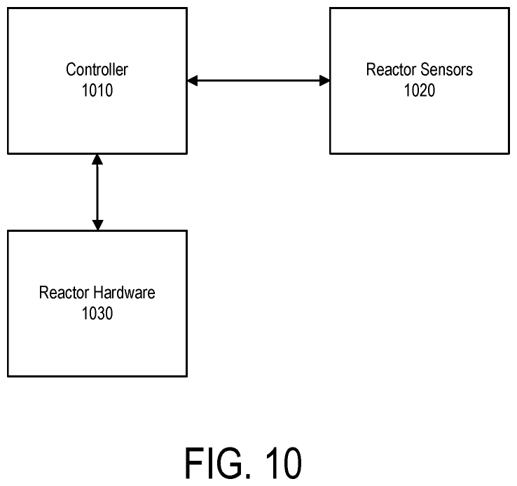

As shown in FIG. 10, illustrated is an example of a block diagram including a controller 1010 configured to send an instruction to reactor hardware 1030 based on reactor sensors 1020. The reactor may include temperature sensors positioned at the steam inlet and/or the steam outlet. The temperature of the steam for heating the reaction may be monitored before entering into the reactor. The temperature sensors may be used to determine whether the heat transfer to the reaction chamber is adequate for an efficient reaction without excessive byproducts. The reactor may include pressure sensors inside of the reaction chambers configured to determine the pressure inside of the reaction chamber. The pressure sensors may also be located at the feed line 130 and be configured to determine the flow rate of the dimethyl ether. The reactors may include steam-to-dimethyl ether sensors to determine the steam-to-dimethyl ether ratio. The reactor may include sensors for detecting carbon dioxide and/or carbon monoxide.

In some embodiments, the reactor hardware 1030 may include a feedline valve configured to control dimethyl ether and steam flowing into the reactor or the inner tube. The reactor sensors 1020 may include a heat sensor configured to determine a temperature of the heat contained by the outer tube. The controller 1010 may be communicatively coupled to the feed line valve and the heat sensor. The controller 1010 may be configured to determine the temperature of the heat contained by the outer tube based on the heat sensor. The controller 1010 may be configured to adjust a feed flow rate with the feed line valve in response to the temperature of the heat satisfying a temperature threshold.

In some embodiments, the reactor hardware 1030 may include a steam-to-dimethyl ether ratio sensor may be configured to output a steam-to-dimethyl ether ratio reading representative of a steam-to-dimethyl ether ratio in the reaction chamber. The controller 1010 may be communicatively coupled to the steam-to-dimethyl ether ratio sensor. The controller 1010 may be configured to determine the steam-to-dimethyl ether ratio reading based on the steam-to-dimethyl ether ratio sensor. The controller 1010 may be configured to compare a steam-to-dimethyl ether ratio reading to a steam-to-carbon ratio. The controller 1010 may be configured to adjust the feed flow rate with the feed line 130 valve in response to the comparing.

In some embodiments, the reactor sensors 1020 may include a pressure sensor configured to output a pressure reading representative of the output pressure inside of the outlet line. A back pressure valve may be included in the outlet line that is configured to control the outlet pressure at the outlet line. The controller 1010 may be communicatively coupled to the pressure sensor and the back pressure valve. The controller 1010 may be configured to determine the pressure reading inside the outlet line based on the pressure sensor. The controller 1010 may also be configured to adjust the outlet pressure with the back pressure valve in the outlet line in response to the pressure reading satisfying an outlet pressure threshold. The pressure in the reactor and the pressure swing adsorption system may need to be maintained at a pressure value. The back pressure valve may be situated at the back end of the pressure swing adsorption unit where the hydrogen product pressure is maintained. The steam pressure inside the reactor itself may be fixed by the back pressure on the hydrogen product. The steam pressure may be controlled at the condensate drum 930. The steam pressure may be adjusted as required to make sure that the steam pressure and the temperature for the heating of the reactants in the reactor 790 is maintained.

In some embodiments, the reactor sensors 1020 may include at least one of a carbon monoxide sensor or a carbon dioxide sensor configured to output at least one of a carbon monoxide reading or a carbon dioxide reading representative of at least one of carbon monoxide or carbon dioxide inside of the reaction chamber. The controller 1010 may be communicatively coupled to the at least one of the carbon monoxide sensor or the carbon dioxide sensor. The controller 1010 may be configured to determine the at least one of a carbon monoxide or a carbon dioxide inside of the reaction chamber based on at least one of the carbon monoxide sensor or the carbon dioxide sensor. The controller 1010 may be configured to adjust the feed flow rate with the feed line 130 valve in response to the at least one of a carbon monoxide reading or a carbon dioxide reading satisfying at least one of a carbon monoxide threshold or a carbon dioxide threshold.

In some embodiments, the reactor sensors 1020 may include a hydrogen sensor configured to output a hydrogen reading representative of the hydrogen at a reactor outlet 140 proximate to an end of the inner tube, the hydrogen sensor reading indicative of a coordinated reaction of the dimethyl ether and the steam with a catalyst 127 in the reaction chamber. The controller 1010 may be communicatively coupled to the hydrogen sensor. The controller 1010 may be configured to determine the hydrogen reading at the reactor outlet proximate to the end of the inner tube based on the hydrogen sensor. The controller 1010 may be configured to adjust the feed flow rate with the feed line valve in response to the hydrogen reading satisfying a hydrogen threshold.

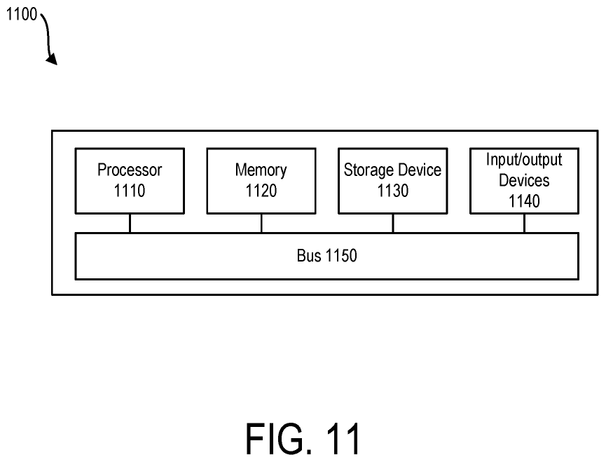

Referring to FIG. 11, the computing system 1100 may include a processor 1110, a memory 1120, a storage device 1130, and an input/output device 1140. The processor 1110, the memory 1120, the storage device 1130, and the input/output device 1140 may be interconnected via a system bus 1150. The processor 1110 is capable of processing instructions for execution within the computing system 1100. Such executed instructions may implement one or more components of, for example, reactor hardware for converting dimethyl ether to hydrogen. In some exemplary embodiments, the processor 1110 may be a single-threaded processor. Alternately, the processor 1110 may be a multi-threaded processor. The processor 1110 is capable of processing instructions stored in the memory 1120 and/or on the storage device 1130 to display graphical information for a user interface provided via the input/output device 1140.

The memory 1120 is a non-transitory computer-readable medium that stores information within the computing system 1100. The memory 1120 may be configured to store data structures representing configuration object databases, for example. The storage device 1130 is capable of providing persistent storage for the computing system 1100. The storage device 1130 may be a floppy disk device, a hard disk device, an optical disk device, or a tape device, or other suitable persistent storage means. The input/output device 1140 provides input/output operations for the computing system 1100. In some exemplary embodiments, the input/output device 1140 includes a keyboard and/or pointing device. In various implementations, the input/output device 1140 includes a display unit for displaying graphical user interfaces.

According to some exemplary embodiments, the input/output device 1140 may provide input/output operations for a network device. For example, the input/output device 1140 may include Ethernet ports or other networking ports to communicate with one or more wired and/or wireless networks (e.g., a local area network (LAN), a wide area network (WAN), the Internet, a public land mobile network (PLMN), and/or the like).

In some exemplary embodiments, the computing system 1100 may be used to execute various interactive computer software applications that may be used for organization, analysis, and/or storage of data in various formats. Alternatively, the computing system 1100 may be used to execute any type of software applications. These applications may be used to perform various functionalities, e.g., planning functionalities (e.g., generating, managing, editing of spreadsheet documents, word processing documents, and/or any other objects, etc.), computing functionalities, communications functionalities, etc. The applications may include various add-in functionalities or may be standalone computing items and/or functionalities. Upon activation within the applications, the functionalities may be used to generate the user interface provided via the input/output device 1140. The user interface may be generated and presented to a user by the computing system 1100 (e.g., on a computer screen monitor, etc.).

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

While the foregoing is directed to implementations of the present disclosure, other and further implementations of the disclosure may be devised without departing from the basic scope thereof, and the scope thereof is determined by the claims that follow.

What is claimed is:

1. A reactor comprising:
an outer tube configured to contain heat, the outer tube having an outer tube diameter;
an inner tube nested inside an outer tube, the inner tube configured to conduct the heat contained by the outer tube, the inner tube having an inner tube diameter smaller than the outer tube diameter, the inner tube having a first end and a second end, the inner tube forming a reaction chamber between the first end and the second end of the inner tube;
a feed line coupled to the first end of the inner tube, the feed line configured to pass dimethyl ether and steam to the inner tube; and
a reactor outlet proximate to the second end of the inner tube, the reactor outlet configured to collect hydrogen from the inner tube and output the hydrogen.

2. The reactor of claim 1, wherein the reaction chamber is configured to house catalyst, the catalyst being configured to receive the heat contained by the outer tube, and wherein the heat contained by the outer tube has a uniform temperature along an outer tube length.

3. The reactor of claim 2, wherein the reaction chamber produces the hydrogen based on a coordinated reaction of the dimethyl ether and steam with the catalyst heated by the heat contained by the outer tube.

4. The reactor of claim 2, wherein the catalyst includes an acid catalyst and a reforming catalyst.

5. The reactor of claim 4, wherein methanol is produced by a hydrolysis of dimethyl ether over the acid catalyst, and wherein a steam reforming of the methanol is produced over the reforming catalyst.

6. The reactor of claim 1, wherein the heat contained by the outer tube is steam heat and the inner tube is configured to conduct heat contained in the outer tube.

7. The reactor of claim 6, wherein the outer tube and the inner tube are oriented in a vertical direction.

8. The reactor of claim 6, wherein the outer tube further comprises a steam inlet for the outer tube and a steam condensate outlet for the outer tube.

9. The reactor of claim 8, wherein a spacing between the outer tube and the inner tube allows the steam to circulate and condense inside the outer tube.

10. A reactor comprising:
a casing configured to contain heat;
a plurality of tubes nested inside the casing, the plurality of tubes configured to conduct the heat contained by the casing, the plurality of tubes each having a first end and a second end, the plurality of tubes each forming a reaction chamber between the first end and the second end of each of the plurality of tubes;
a feed line coupled to each of the first end of the plurality of tubes, the feed line configured to pass dimethyl ether and steam to the plurality of tubes; and
a reactor outlet proximate to each of the second end of the plurality of tubes, the reactor outlet configured to collect hydrogen from the plurality of tubes and output the hydrogen.

11. The reactor of claim 10, wherein the heat is generated by a plurality of electric heating elements inside the casing and outside the plurality of tubes and wherein the plurality of tubes is configured to conduct the heat contained by the casing.

12. The reactor of claim 10, wherein the casing further comprises a refractory surface along an inside portion of the casing and wherein the casing further comprises a layer of insulation between the refractory surface and an outside portion of each of the plurality of tubes.

13. A reactor comprising:
a shell configured to contain heat;
a plurality of tubes nested inside the shell, the plurality of tubes configured to conduct heat from the heat contained inside the shell, the plurality of tubes each having a first end and a second end, and the plurality of tubes each forming a reaction chamber between the first end and the second end;
a feed line coupled to each of the first end of the plurality of tubes, the feed line configured to receive dimethyl ether and steam; and
a reactor outlet proximate to each of the second end of the plurality of tubes, the reactor outlet configured to output hydrogen.

14. The reactor of claim 13, comprising:
a plurality of burners inside the shell, the burners configured to generate the heat contained inside the shell; and
a shell outlet configured to output flue gas.

15. The reactor of claim 14, wherein the plurality of burners are configured to turn on simultaneously maintaining uniform temperature and wherein the shell is a fire box.

16. A reactor comprising:
a shell configured to contain heat;
a top tube plate coupled to a top portion of the shell, the top tube plate including a plurality of top tube plate apertures;
a bottom tube plate coupled to a bottom portion of the shell, the bottom tube plate including a plurality of bottom tube plate apertures;
a plurality of tubes configured to extend between the top tube plate and the bottom tube plate, each of the plurality of tubes configured to be inserted inside a top tube plate aperture of the plurality of top tube plate apertures and a bottom tube plate aperture of the plurality of bottom tube plate apertures; the plurality of tubes configured to conduct heat from the heat contained inside the shell, the plurality of tubes each forming a reaction chamber between the top tube plate and the bottom tube plate;
a feed line proximate to the top portion of the shell, the feed line being configured to pass dimethyl ether and steam to the plurality of tubes; and
a reactor outlet proximate to the bottom portion of the shell, the reactor outlet configured to collect hydrogen from the plurality of tubes and output the hydrogen.

17. The reactor of claim 16, wherein the reaction chamber is configured to house a catalyst, the catalyst being configured to receive the heat contained by the plurality of tubes, and wherein the heat contained by the shell has a uniform temperature between the top tube plate and the bottom tube plate.

18. The reactor of claim 17, wherein the shell and the plurality of tubes are oriented in a vertical direction.

19. The reactor of claim 17, wherein the shell further comprises an inlet for heating the plurality of tubes with at least one of steam or heating oil, and wherein the shell further comprises an outlet for outputting condensate from inside the shell.

20. The reactor of claim 17, wherein a spacing between the shell and the plurality of tubes allows at least one of steam or heating oil to circulate inside the plurality of tubes.

21. A reactor comprising:
a shell including a reaction chamber, the reaction chamber configured to contain a fluidized catalyst reaction bed;
a heat source configured to extend from a top portion of the reaction chamber to a bottom portion of the reaction chamber, the heat source configured to heat the fluidized catalyst reaction bed;
a feed line proximate to the bottom portion of the reaction chamber, the feed line including a plurality of feed line apertures, each feed line aperture of the plurality of feed line apertures is configured to pass dimethyl ether and steam to the reaction chamber; and
a reactor outlet proximate to the top portion of the shell, the reactor outlet configured to collect hydrogen from the reaction chamber and output the hydrogen.

22. The reactor of claim 21, wherein the shell is oriented in a vertical direction and wherein the fluidized catalyst reaction bed is configured to circulate inside the reaction chamber.

23. The reactor of claim 21, wherein the heat source winds in alternating directions through the reaction chamber, wherein the heat source is at least one of an electric coil or a tube containing steam, and wherein the fluidized catalyst reaction bed is configured to conduct the heat from at least one of the electric coil or tube containing steam.

24. The reactor of claim 21, wherein the reaction chamber produces the hydrogen based on a coordinated reaction of the dimethyl ether and steam with the fluidized catalyst reaction bed heated by the heat source.

25. The reactor of claim 21, wherein the shell further comprises a dimethyl ether and steam outlet coupled to the feed line, the dimethyl ether and steam and steam outlet configured to output excess dimethyl ether and steam and steam from the reaction chamber to the feed line for recycling the excess dimethyl ether and steam.

26. A reaction-measuring system comprising:
a feed line valve configured to control dimethyl ether and steam flowing into an inner tube, the inner tube being nested inside an outer tube, the inner tube configured to conduct heat contained by the outer tube, the inner tube having an inner tube diameter smaller than an outer tube diameter, the inner tube each forming a reaction chamber;
a heat sensor configured to determine a temperature of the heat contained by the outer tube; and
a controller communicatively coupled to the feed line valve and the heat sensor, the controller configured to:
determine the temperature of the heat contained by the outer tube based on the heat sensor; and
adjust, in response to the temperature of the heat satisfying a temperature threshold, a feed flow rate with the feed line valve.

27. The reaction-measuring system of claim 26, further comprising:
a steam-to-dimethyl ether ratio sensor configured to output a steam-to-dimethyl ether ratio reading representative of a steam-to-dimethyl ether ratio in the reaction chamber,
wherein the controller is communicatively coupled to the steam-to-dimethyl ether ratio sensor and is further configured to:
determine the steam-to-dimethyl ether ratio reading based on the steam-to-carbon ratio sensor;
compare the steam-to-dimethyl ether ratio reading to a steam-to-a-carbon ratio; and
adjust, in response to the comparing, the feed flow rate with the feed line valve.

28. The reaction-measuring system of claim 26, further comprising:
a pressure sensor configured to output a pressure reading representative of the outlet pressure in the outlet line; and
a back pressure valve in the outlet line configured to control the outlet pressure at the outlet line,
wherein the controller is communicatively coupled to the pressure sensor and the back pressure valve, and wherein the controller is further configured to:
determine the pressure reading inside the outlet line based on the pressure sensor; and
adjust, in response to the pressure reading satisfying an outlet pressure threshold, the outlet pressure with the back pressure valve in the outlet line.

29. The reaction-measuring system of claim 26, further comprising:
at least one of a carbon monoxide sensor or a carbon dioxide sensor configured to output at least one of a carbon monoxide reading or a carbon dioxide reading representative of at least one of carbon monoxide or carbon dioxide inside of the reaction chamber;
wherein the controller is communicatively coupled to the at least one of the carbon monoxide sensor or the carbon dioxide sensor and the controller is further configured to:
determine the at least one of a carbon monoxide or a carbon dioxide inside of the reaction chamber based on at least one of the carbon monoxide sensor or the carbon dioxide sensor; and
adjust, in response to the at least one of a carbon monoxide reading or a carbon dioxide reading satisfying at least one of a carbon monoxide threshold or a carbon dioxide threshold, the feed flow rate with the feed line valve.

30. The reaction-measuring system of claim 26, further comprising:
a hydrogen sensor configured to output a hydrogen reading representative of the hydrogen at a reactor outlet proximate to an end of the inner tube, the hydrogen sensor reading indicative of a coordinated reaction of the dimethyl ether and the steam with a catalyst in the reaction chamber,
wherein the controller is communicatively coupled to the hydrogen sensor and is further configured to:
determine the hydrogen reading at the reactor outlet proximate to the end of the inner tube based on the hydrogen sensor; and
adjust, in response to the hydrogen reading satisfying a hydrogen threshold, the feed flow rate with the feed line valve.
